(19) United States
(12) Patent Application Publication
(10) Pub. No.: US 2018/0058353 A1
(43) Pub. Date: Mar. 1, 2018

(54) METHOD AND SYSTEM FOR OPERATING AN ENGINE STOP-START SYSTEM IN A VEHICLE

(71) Applicant: FORD GLOBAL TECHNOLOGIES, LLC, Dearborn, MI (US)

(72) Inventors: Hafiz Shafeek Khafagy, Dearborn, MI (US); Hank L. Kwong, Farmington Hills, MI (US); David H. Schmitt, Livonia, MI (US); Jamal Kanso, Dearborn, MI (US)

(21) Appl. No.: 15/244,515

(22) Filed: Aug. 23, 2016

(51) Int. Cl. F02D 41/04; F02D 41/02; F02D 41/06; B60R 16/033

(52) U.S. Cl. CPC F02D 41/042; F02D 41/0225; F02D 41/065; F02D 2200/50; F02D 2200/606; F02D 2200/604; F02D 2250/12; B60R 16/033

(57) ABSTRACT

A method to control engine stop-start in a vehicle is provided. The method includes a controller outputting an engine command to auto-start an engine based on detection of shifter position change to one of a first set of shifter positions and whether a first predetermined time threshold has expired following the shifter position change in response to presence of an engine auto-stop mode and one of a set of preselected drive modes. The vehicle may include an engine, a traction battery, and a controller. The traction battery selectively powers components of the vehicle when the engine is auto-stopped. The controller is programmed to, in response to detecting an engine auto-stop condition, one of a set of preselected drive modes, and a shifter position change to one of a first set of shifter positions with a brake application, output an engine command to engage engine auto-start.

### TECHNICAL FIELD

This disclosure relates to a method and a system for operating an engine stop-start system in a motor vehicle.

### BACKGROUND

Vehicles equipped with stop-start systems are powered in part by conventional internal combustion engines. A controller may initiate an automatic stop or start of the engine under certain operating conditions. For example, the stop-start system may automatically stop the engine when the vehicle is stopped or decelerating and the engine is not required for propulsion or other purposes. At a later time, the stop-start system may restart the engine when required for propulsion or other purposes, e.g., when the brake pedal is released and/or the accelerator pedal is engaged. By disabling the engine when possible, overall fuel consumption is reduced.

### SUMMARY

A method to control engine stop-start in a vehicle includes a controller outputting an engine command to auto-start an engine based on detection of a shifter position change to one of a first set of shifter positions and whether a first predetermined time threshold has expired following the shifter position change in response to presence of an engine auto-stop mode and one of a set of preselected drive modes. The first set of shifter positions may include a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, or a sport adaptive mode. The method may further include, in response to detection of a brake release, outputting via the controller an engine command to engage engine auto-start. The method may further include, in response to detection of a brake not being released, outputting via the controller an engine command for the engine to remain auto-stopped. The method may further include, in response to detection of a shifter position change to one of a second set of shifter positions and the engine running during the shifter position change, outputting via a controller an engine command for the engine to remain running. The second set of shifter positions may include a sport mode, a tow/haul mode, a mud and sand mode, a mud and ruts mode, a rock/crawl mode, a hill descent control mode, a low 4×4 with hill descent control (HDC) mode, a low 4×4 without HDC mode, a sport adaptive mode, or a baja mode. The method may further include, in response to detection that there has not been a shifter position change from one of the preselected set of drive modes to one of a second set of shifter positions, a predetermined time threshold not expiring, and a brake application, outputting via a controller an engine command for the engine to remain auto-stopped. The method may further include, in response to detection of an expiration of a second predetermined time threshold and a brake release, outputting via a controller an engine command to auto-start. The second predetermined time threshold may be based on vehicle conditions and driver input.

A method to control engine stop-start in a vehicle includes outputting via a controller an engine command to auto-stop based on detection of a shifter position change from one of the preselected set of drive modes to one of a first set of shifter positions and whether a brake is applied during the shifter position change in response to detection of an engine running and one of a preselected set of drive modes. The first set of shifter positions may include a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, and a sport adaptive mode. The method may further include, in response to expiration of a predetermined time threshold while the brake is applied, outputting via the controller an engine command to engage auto-stop. The predetermined time threshold may be based on an accessible driver input history. The method may further include, in response to detection of a shifter position change to one of a second set of shifter positions, outputting via the controller an engine command for the engine to remain running. The second set of shifter positions may include a sport mode, a tow/haul mode, a mud and sand mode, a mud and ruts mode, a rock/crawl mode, a hill descent control mode, a low 4×4 with hill descent control (HDC) mode, a low 4×4 without HDC mode, a sport adaptive mode, or a baja mode.

A vehicle includes an engine, a traction battery, and a controller. The traction battery selectively powers components of the vehicle when the engine is auto-stopped. The controller is programmed to, in response to detecting an engine auto-stop condition, one of a set of preselected drive modes, and a shifter position change to one of a first set of shifter positions with a brake application, output an engine command to engage engine auto-start. The first set of shifter positions may be a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, or a sport adaptive mode. The controller may be further programmed to output an engine command to remain auto-stopped in response to detecting a brake release during the shifter position change to one of the first set of shifter positions. The controller may be further programmed to output an engine command for the engine to auto-start in response to detection of expiration of a predetermined time threshold and detection of a brake release. The predetermined time threshold may be based on an accessible driver input history.

### BRIEF DESCRIPTION OF THE DRAWINGS

FIG. 1 is a schematic diagram illustrating an example of a vehicle.

FIG. 2 is a flow chart illustrating an example of an algorithm to support engine auto stop-start operations of a vehicle.

FIG. 3 is a flow chart illustrating another example of an algorithm to support engine auto stop-start operations of a vehicle.

FIGS. 4A through 4D depict a matrix illustrating an example of a control strategy for engine auto stop-start operations of a vehicle.

FIGS. 5A through 5D depict a matrix illustrating another example of a control strategy for engine auto stop-start operations of a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

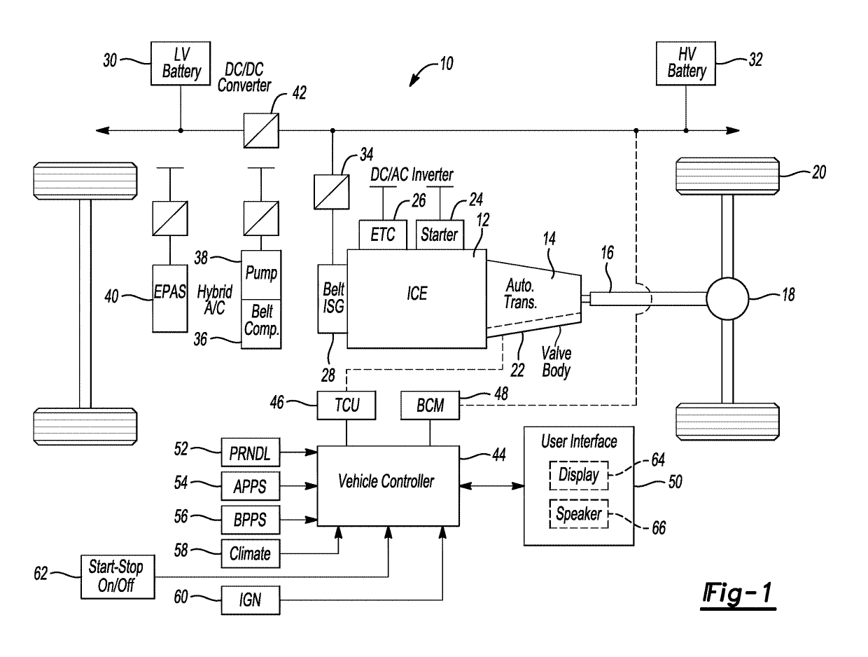

FIG. 1 shows a schematic diagram of a vehicle, referred to as a vehicle 10 herein. The vehicle 10 includes an internal combustion engine 12 and an automatic transmission 14. Torque delivered from a crankshaft of the internal combustion engine 12 is delivered through multiple-ratio gearing of the transmission 14 to a driveshaft 16 and to a final drive differential-and-axle assembly 18 for traction wheels 20. The gearing for the transmission 14 may establish multiple torque ratios under the control of a valve body 22. The ratios may be established by an engagement and disengagement of clutches and brakes in a conventional fashion. The transmission 14 may be configured for a neutral state by disengaging a forward drive clutch. A starter motor 24 under the control of a low-voltage battery (not shown) can be used to start the engine 12 under cold-start conditions. The vehicle 10 may also include an electronic throttle control 26 for the engine 12. While vehicle 10 is depicted with an automatic transmission, one or more embodiments of the present application may also be employed in vehicles having manual transmissions.

The vehicle 10 may include an automatic stop-start system that automatically shuts down and restarts the engine 12 to reduce an amount of time the engine spends idling, thereby reducing fuel consumption and emissions. Automatically shutting down the engine may be advantageous for vehicles that spend significant amounts of time waiting at traffic lights or frequently come to a stop in traffic jams. While the automatic stop-start feature is present in HEVs, automatic stop-start systems may also appear in vehicles that lack a hybrid electric powertrain.

The vehicle 10 may enter an auto-stop mode (i.e., the engine is auto-stopped) when certain vehicle propulsion conditions are met, such as when the driver has applied the brakes and the vehicle speed is below a predetermined speed threshold. Once the driver indicates a request for vehicle propulsion (e.g., by releasing the brake pedal), a powertrain controller may automatically restart the engine 12.

To this end, the engine 12 may be drivably connected to a crankshaft pulley, which drives a belt-driven integrated starter-generator 28 in one or more embodiments of the present application. Although a belt-drive is disclosed, other types of drives could be used to provide a driving connection between the engine 12 and the starter-generator 28. For example, a flexible chain drive or a geared drive could be used, depending on design choice. The starter-generator 28 may be electrically coupled to a voltage source, such as a low-voltage battery 30 or a high-voltage battery 32. The high-voltage battery 32 may be connected to the starter-generator 28 through a DC/AC inverter 34.

Since automobile accessories like air conditioners and water pumps have typically been designed to run off a serpentine belt on an engine, those systems may need to be redesigned to function properly when the engine is turned off. In full HEVs, an electric motor is typically used to power these devices instead. In vehicle 10, hybrid vehicle accessories, such as an air conditioning compressor 36, a fuel pump 38 and a power steering pump 40, may be electrically powered by the low-voltage battery 30. The voltage sources may be separated by a DC/DC converter 42, which may adjust, or “step down” the voltage level to allow the high-voltage battery 32 to charge the low-voltage battery 30.

A vehicle control system, shown generally as a vehicle controller 44, may be provided to control various components and subsystems of the vehicle 10, including the automatic stop-start system. The vehicle controller 44 may be a general vehicle controller, such as a vehicle system controller (VSC). Although it is shown as a single controller, the vehicle controller 44 may include multiple controllers or may include multiple software components or modules embedded in a single controller to control various vehicle systems, sub-systems, and components. For example, the vehicle controller 44 may include the powertrain controller to control various aspects of the micro-hybrid powertrain. The powertrain controller could be a separate hardware device, or may include a separate powertrain control module (PCM), which could be software embedded within a general purpose controller, such as the VSC. The vehicle controller 44 may generally include any number of microprocessors, ASICs, ICs, memory (e.g., FLASH, ROM, RAM, EPROM and/or EEPROM) and software code to co-act with one another to perform a series of operations.

The vehicle controller 44 may communicate with other controllers over a vehicle-wide network, such as a controller area network (CAN). The CAN may be a hardline vehicle connection (e.g., bus) and may be implemented using any number of communication protocols. For example, the vehicle controller 44 may communicate with a transmission control unit (TCU) 46 and a battery control module (BCM) 48, which is electrically coupled to the high-voltage battery 32. Alternatively, the aforementioned controllers may be software control modules contained within the vehicle controller 44 or other general purpose controllers residing on the vehicle. Some or all of these various controllers or software control modules can make up a control system in accordance with the present application. It will be appreciated, however, that various aspects of the disclosed subject matter are not limited to any particular type or configuration of the vehicle controller 44, or to any specific control logic for managing operation of the micro-hybrid powertrain or other vehicle systems.

The vehicle controller 44 may communicate with each individual vehicle system to monitor and control vehicle operation according to programmed algorithms and control logic. In this regard, the vehicle controller 44 may help manage the different energy sources available and the engine status in order to optimize fuel economy and/or maximize the vehicle's range. The vehicle controller 44 may include a programmable digital computer and suitable input/output circuitry or the like that is configured to receive the various input signals indicative of a condition of the vehicle system components. The input signals may be communicated from the vehicle system components themselves, or device-specific controllers, or may be received from various vehicle system sensors, antennas, or manual inputs, such as those described above. The vehicle controller 44 may process these input signals and others according to logic rules to monitor and control operation of the micro-hybrid powertrain.

In addition to the foregoing, the vehicle 10 may include a user interface 50 to facilitate communications with a driver. The user interface may communicate with the vehicle controller 44 and may provide relevant vehicle content to the driver. The vehicle controller 44 may be configured to receive input signals that are indicative of current operating and/or environmental conditions of the vehicle 10, including signals relevant to the operation of the automatic stop-start system. For example, the vehicle controller 44 may receive input signals from the TCU 46 and the BCM 48, as well as a gear selector (PRNDL) 52, an accelerator pedal position sensor (APPS) 54, a brake pedal position sensor (BPPS) 56, a climate control module 58, an ignition switch (IGN) 60, and an automatic stop-start switch 62, or the like. The automatic stop-start switch 62 can allow the driver to manually deactivate the automatic stop-start system, thereby preventing engine auto-stops at the driver's request. The vehicle controller 44 may provide output to the user interface 50 such that the user interface 50 conveys vehicle operating information, such as information relating to the operation of the automatic stop-start system, to the driver. The user interface 50 may communicate relevant vehicle information to a driver visually through a display 64 and/or audibly via a speaker 66.

The display 64 may be electrically connected to a display controller (not shown). The display controller may communicate with the powertrain controller, the TCU 46, the BCM 48, and other dedicated or general purpose controllers, such as the vehicle controller 44. The display controller may gather data from various vehicle systems and components, which may be accessed via the CAN. Moreover, the display controller may provide data to the display 64 for conveying vehicle operation information to the driver in a meaningful manner. Signals output from the various vehicle systems and components may be processed, and display computations may be carried out, in the vehicle controller 44, the display controller or the display 64, or some combination thereof. The display controller may be a separate controller or may be integrated with the vehicle controller 44 or another general or dedicated vehicle controller. Thus, as with the powertrain controller, all monitoring, processing and control operations that may be performed by a separate display controller may be described herein as being carried out by the vehicle controller 44. In addition to the automatic stop-start switch 62, the vehicle controller 44 may automatically prevent engine auto-stops during certain operating conditions.

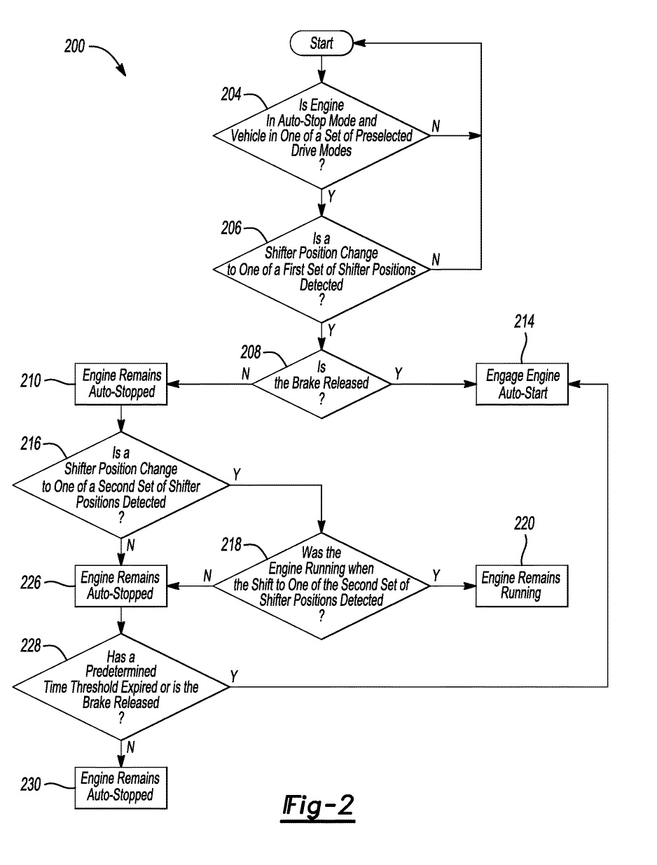

Control strategies may assist in directing initiation of stop-start engine commands based on a detection of certain conditions. FIG. 2 shows an example of an algorithm supporting engine auto stop-start operations of a vehicle, referred to as an algorithm 200 herein. The algorithm 200 may be used with various vehicle configurations such as a vehicle including a traditional PRNDL system, a non-pushbutton shift by wire system, and a push button shift by wire system.

The algorithm 200 is representative of an example of programming to operate the vehicle. For example, in operation 204, a controller of the vehicle may determine whether the engine is in auto-stop mode and whether the vehicle is in one of a set of preselected drive modes. The set of preselected drive modes may include, but is not limited to, a sport mode, a weather mode, and an economy mode. One or more sensors may be located throughout the vehicle to detect a variety of conditions of vehicle components. The one or more sensors may be in communication with the controller to deliver signals indicating detection or no detection of the conditions. In the event auto-stop mode is detected and the vehicle is in one of the set of preselected drive modes, the controller may determine whether a shifter position changes to one of a first set of shifter positions in operation 206. Examples of shifter positions of the first set of shifter positions include normal base pedal mode, winter/wet/snow mode, grass/gravel/snow mode, and economy mode.

In the event the controller determines the engine is not in auto-stop mode or the vehicle is not in one of the preselected drive modes in operation 204, the control strategy may revert back to start. In the event the controller determines there has not been a shifter position change to one of the first set of shifter positions in operation 206, the controller strategy may revert back to start.

In the event a shifter position change to one of the first set of shifter positions is detected in operation 206, the controller may then determine whether the brake is applied or released in operation 208. If the controller determines that the brake is not released in operation 208, the controller may direct the engine to remain auto-stopped in operation 210. If the controller determines that the brake is released in operation 208, the controller may direct the engine to auto-start in operation 214.

In operation 216, the controller may determine whether a shifter position has changed to one of a second set of shifter positions. Examples of the second set of shifter positions include a sport mode, a tow/haul mode, a mud and sand mode, a mud and ruts mode, a rock/crawl mode, a hill descent control mode, a low 4×4 with hill descent control (HDC) mode, a low 4×4 without HDC mode, a sport adaptive mode, and a baja mode. In the event the controller detects a shift to one of the second set of shifter positions, the controller may determine whether the engine was running during the shift in operation 218. In operation 220 the controller directs the engine to remain running in the event a shift to one of the second set of shifter positions is detected in operation 218.

If a shift to one of the second set of shifter positions is not detected in operation 216 or if the controller determines the engine is not running in operation 218, the controller may direct the engine to remain auto-stopped in operation 226.

In operation 228, the controller may determine whether a predetermined time threshold has expired or whether the brake has been released. The predetermined time threshold may be reflective of an amount of time between shifter position changes by the driver and predicted driver intentions. The predetermined time threshold may vary depending on the type of vehicle component. While the predetermined time threshold is tunable to accommodate various vehicle conditions and driver inputs, in one example, the predetermined time threshold may be between 200 and 300 milliseconds. For example, a de-bounce timer may be in communication with the controller and vehicle components to send time data to the controller indicating whether a shifter position has changed within the predetermined threshold. The predetermined time threshold may also be based on driver historical data accessed by the controller to assist in predicting driver intentions and to reduce any nuisance the driver may experience during shifter position changes.

If the predetermined time threshold has expired or if the brake is released in operation 228, the controller may direct engagement of engine auto-start in operation 214. If a shifter position change occurs before the predetermined time threshold has expired or the brake is not released, the controller may direct the engine to remain auto-stopped in operation 230.

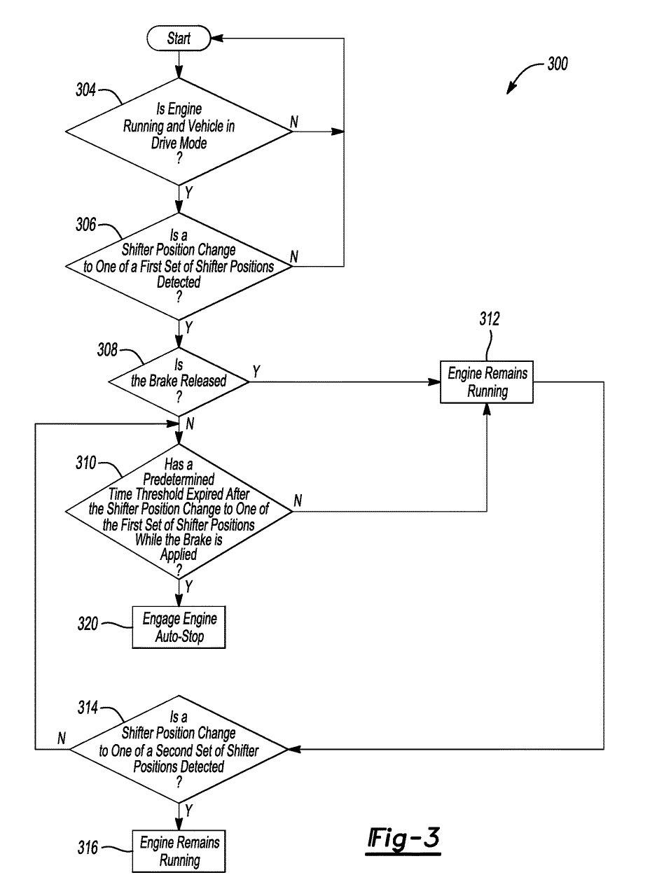

FIG. 3 shows an example of another algorithm for initiating engine auto stop-start engine commands based on a detection of certain conditions, referred to generally as algorithm 300. In operation 304 the controller may determine whether the engine is running and whether the vehicle is in one of a set of preselected drive modes. Examples of drive modes include the terrain mode, a sport mode, a normal mode, a tow/haul/grade assist mode, a mud and sand mode, a baja mode, a rock/crawl mode, an economy mode, a hill descent control mode, a low 4×4 with HDC mode, a low 4×4 without HDC mode, and a sport adaptive mode.

In the event the controller determines the engine is not running and the vehicle is not in drive mode in operation 304, the control strategy may revert back to start. In the event the controller determines there has not been a shifter position change to one of the first set of gear positions in operation 306, the controller strategy may revert back to start.

In operation 306, the controller may determine whether a shifter position has changed to one of the first set of preselected shifter positions described above. If a brake release is detected in operation 308, the controller may direct the engine to remain running. If a brake release is not detected in operation 308, the controller may determine whether a predetermined time threshold has expired for one of the first set of shifter positions and whether the brake is applied in operation 310.

If the predetermined threshold has not expired with the brake applied in operation 310, the controller may direct the engine to remain running in operation 312. If the controller detects that the predetermined threshold has expired and the brake is applied in operation 310, the controller may direct engagement of the engine auto-stop in operation 320. As described above, the predetermined time threshold is tunable based on various scenarios relating to vehicle conditions and driver inputs. In one example, the predetermined time threshold may be between 200 and 300 milliseconds. A de-bounce timer may be in communication with the controller and vehicle components to send time data to the controller indicating whether a shifter position has changed within the predetermined threshold. The predetermined time threshold may also be based on driver historical data accessed by the controller to assist in predicting driver intentions and to reduce any nuisance the driver may experience during shifter position changes.

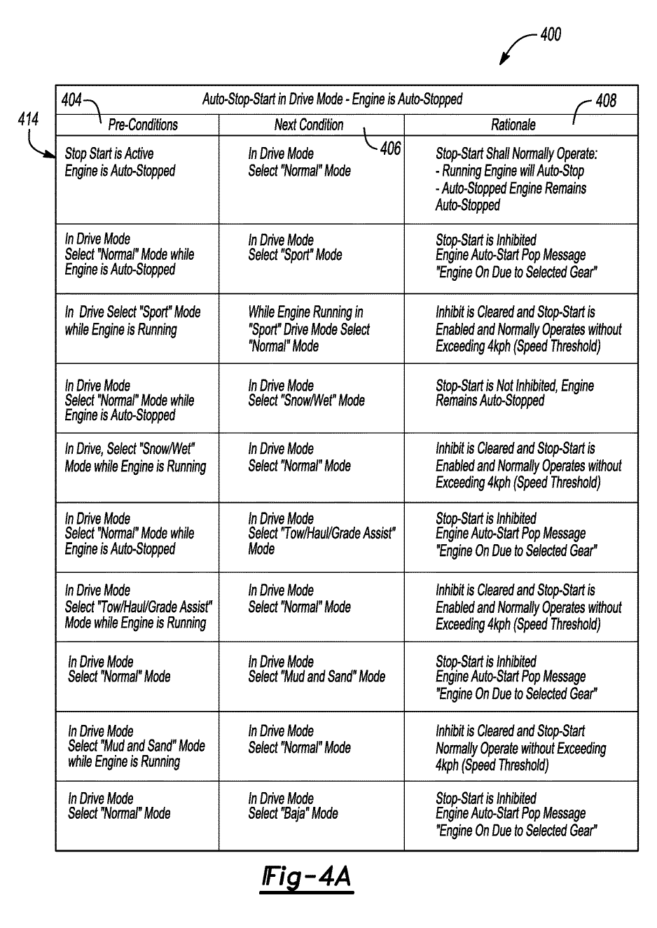

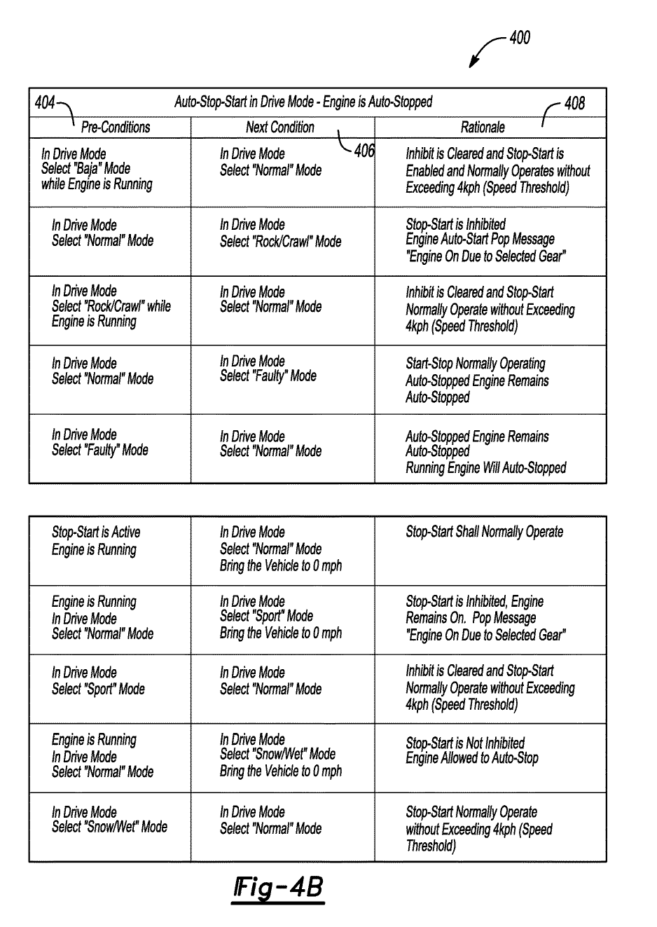

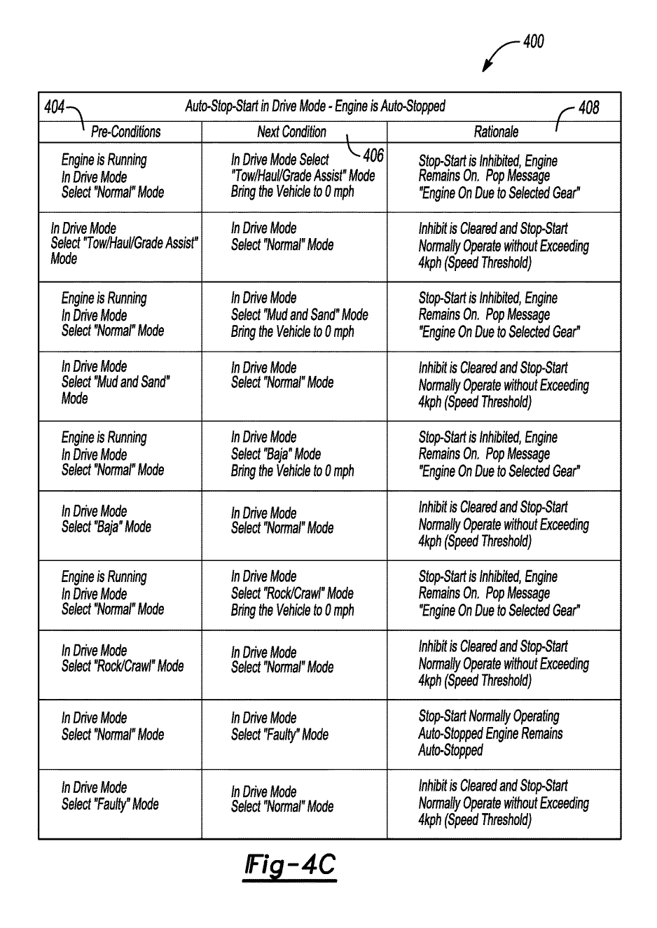

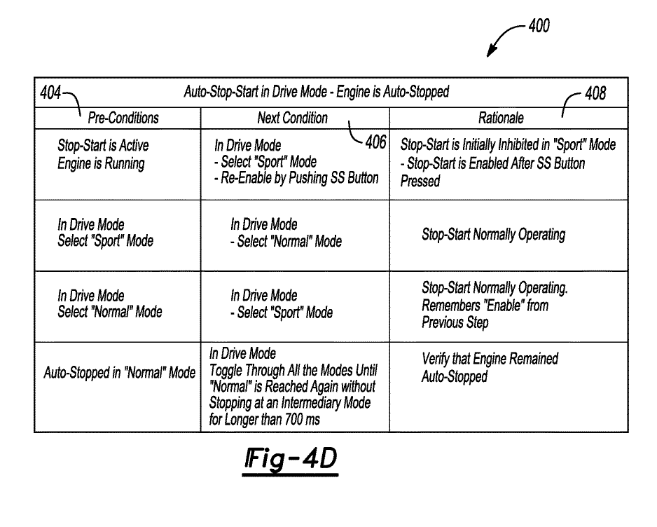

FIGS. 4A through 4D depict an example of a matrix of a control strategy for engine auto stop-start operations of a vehicle having an engine auto-stopped, referred to generally as a matrix 400. The matrix includes columns identified as pre-conditions 404, next conditions 406, and rationale 408. The pre-conditions 404 may represent various examples of vehicle conditions while in one of a set of preselected drive modes and the engine is auto-stopped. The next conditions 406 may represent various examples of engine commands based on the shifter position changes from one of the preselected drive modes to another shifter position. The controller may monitor conditions of the vehicle to identify a status of the pre-conditions 404 and direct operation of an engine stop-start system in response to the next conditions 406.

The pre-conditions 404 include a shifter position status and an engine run condition status. The matrix 400 shows the shifter position status to be a drive mode position. The engine run condition status may indicate either a running status or an auto-stopped status.

The next conditions 406 include a shifter position status and an indication of a type of shifter position change. The shifter position status indicates whether the vehicle has shifted from one of the preselected drive modes to another shifter position. The rationale 408 column indicates whether the controller has directed the engine to auto-stop or auto-start based on whether a predetermined time threshold has expired. The predetermined time threshold may be based on vehicle conditions and driver inputs.

For example, in line item 414 the engine is in auto-stop mode with a drive mode gear position as shown in pre-condition 404. The controller may detect a shift to another shifter position, such as a normal mode. Rationale 408 indicates that under these conditions the controller will direct the engine to auto-stop.

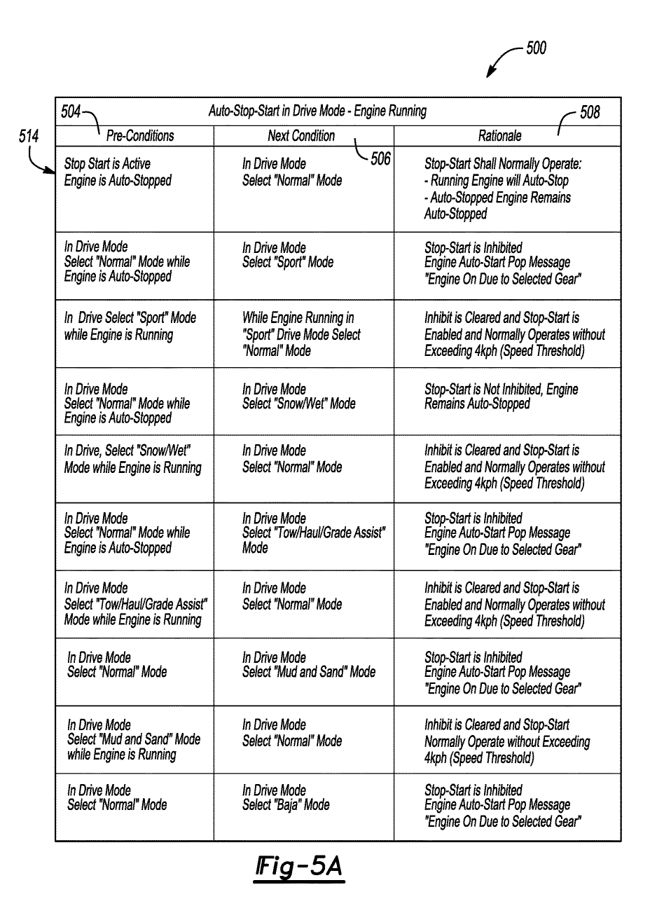

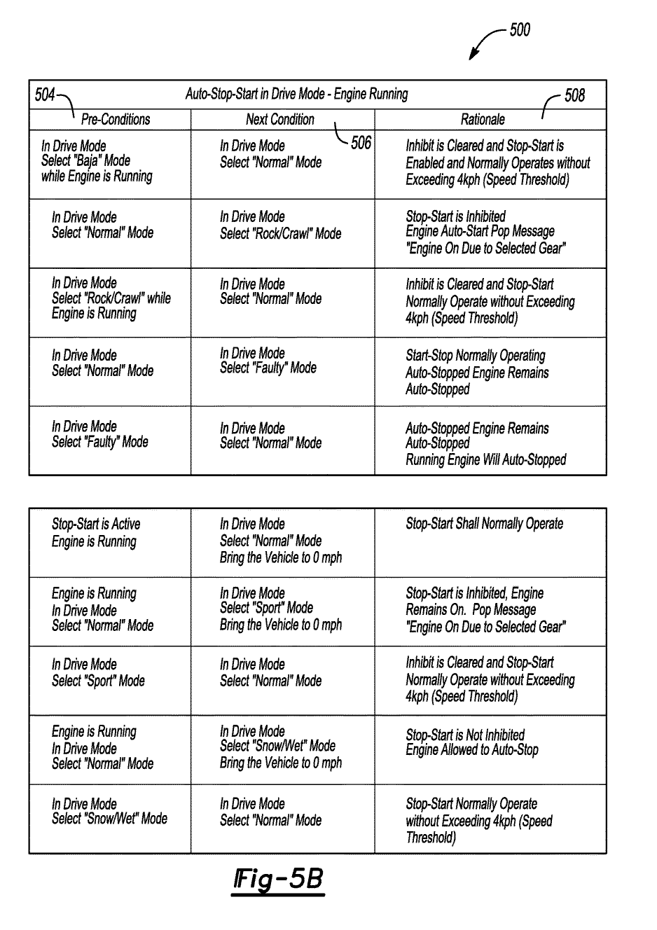

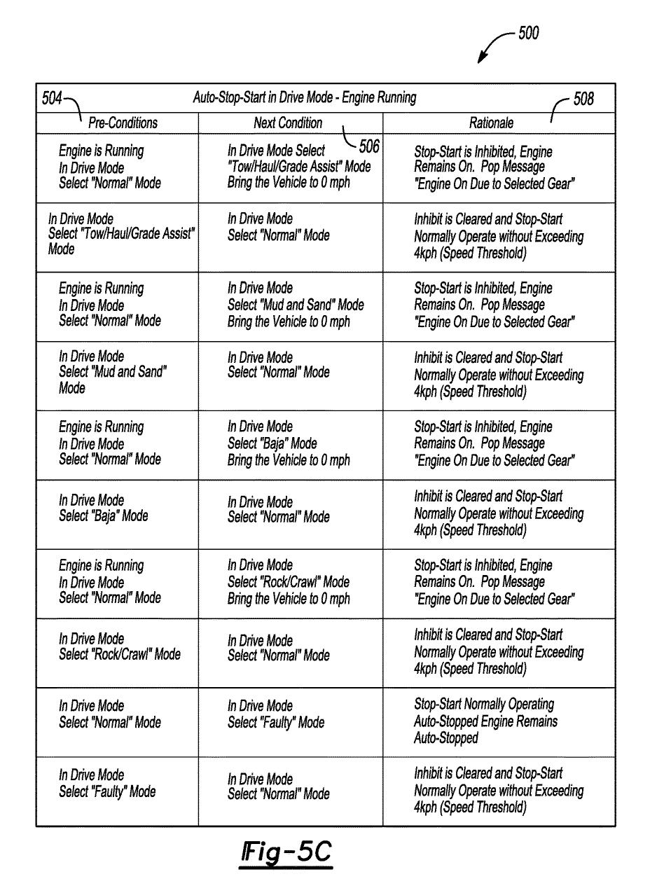

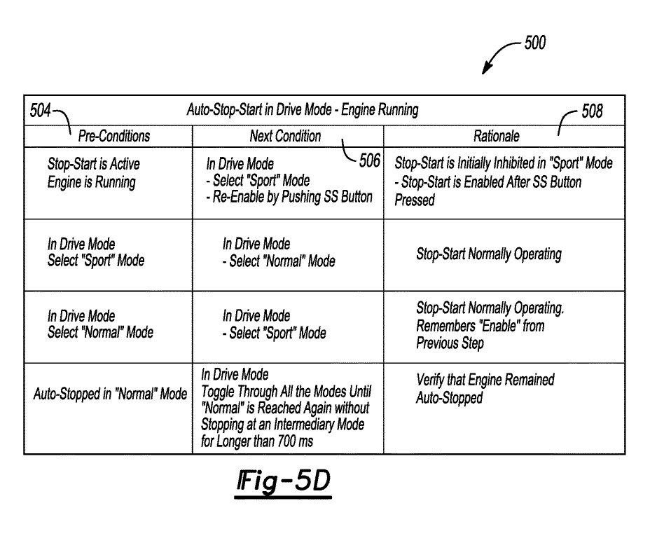

FIGS. 5A through 5D depict another example of a matrix of a control strategy for engine auto stop-start operations of a vehicle having an engine running, referred to generally as a matrix 500. The matrix 500 includes columns identified as pre-conditions 504, next conditions 506, and rationale 508. The pre-conditions 504 may represent various examples of vehicle conditions while in a drive mode and the engine is running. The next conditions 506 may represent various examples of engine commands based on a shifter position change from the drive mode to another shifter position. The controller may monitor conditions of the vehicle to identify a status of the pre-conditions 504 and direct operation of an engine stop-start system in response to the next conditions 506.

The pre-conditions 504 include a shifter position status and an engine run condition status. The matrix 500 shows the shifter position status to be one of the preselected drive modes. The engine run condition status may indicate either a running status or an auto-stopped status.

The next conditions 506 include a shifter position status and an indication of a type of shifter position change. The shifter position status indicates whether the shifter position has changed. The rationale 508 column indicates whether the controller has directed the engine to auto-stop or auto-start based on whether a predetermined time threshold has expired. The predetermined time threshold may be based on vehicle conditions and driver inputs.

For example, in line item 514 the engine is running and the vehicle is in one of the preselected drive modes as shown in pre-condition 504. The controller may detect a shifter position change to another shifter position. Rationale 508 indicates that under these conditions the controller will direct the engine to engage auto-stop.

While various embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to marketability, appearance, consistency, robustness, customer acceptability, reliability, accuracy, etc. As such, embodiments described as less desirable than other embodiments or prior art implementations with respect to one or more characteristics are not outside the scope of the disclosure and can be desirable for particular applications.

What is claimed is:

1. A method to control engine stop-start in a vehicle comprising:
responsive to presence of an engine auto-stop mode and one of a set of preselected drive modes, outputting via a controller an engine command to auto-start an engine based on detection of shifter position change to one of a first set of shifter positions and whether a first predetermined time threshold has expired following the shifter position change.

2. The method of claim 1, wherein the first set of shifter positions is a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, or a sport adaptive mode.

3. The method of claim 1 further comprising in response to detection of a brake release, outputting via the controller an engine command to engage engine auto-start.

4. The method of claim 1 further comprising in response to detection of a brake not being released, outputting via the controller an engine command for the engine to remain auto-stopped.

5. The method of claim 4 further comprising in response to detection of a shifter position change to one of a second set of shifter positions and the engine running during the shifter position change, outputting via a controller an engine command for the engine to remain running.

6. The method of claim 5, wherein the second set of shifter positions is a sport mode, a tow/haul mode, a mud and sand mode, a mud and ruts mode, a rock/crawl mode, a hill descent control mode, a low 4×4 with hill descent control (HDC) mode, a low 4×4 without HDC mode, a sport adaptive mode, or a baja mode.

7. The method of claim 4 further comprising in response to detection that there has not been a shifter position change from one of the preselected set of drive modes to one of a second set of shifter positions, a predetermined time threshold not expiring, and a brake application, outputting via a controller an engine command for the engine to remain auto-stopped.

8. The method of claim 4 further comprising in response to detection of an expiration of a second predetermined time threshold and a brake release, outputting via a controller an engine command to auto-start.

9. The method of claim 8, wherein the second predetermined time threshold is based on vehicle conditions and driver input.

10. A method to control engine stop-start in a vehicle comprising:
responsive to detection of an engine running and one of a preselected set of drive modes, outputting via a controller an engine command to auto-stop based on detection of a shifter position change from one of the preselected set of drive modes to one of a first set of shifter positions and whether a brake is applied during the shifter position change.

11. The method of claim 10, wherein the first set of shifter positions is a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, and a sport adaptive mode.

12. The method of claim 10 further comprising in response to expiration of a predetermined time threshold while the brake is applied, outputting via the controller an engine command to engage auto-stop.

13. The method of claim 12, wherein the predetermined time threshold is based on an accessible driver input history.

14. The method of claim 12 further comprising in response to detection of a shifter position change to one of a second set of shifter positions, outputting via the controller an engine command for the engine to remain running.

15. The method of claim 14, wherein the second set of shifter positions is a sport mode, a tow/haul mode, a mud and sand mode, a mud and ruts mode, a rock/crawl mode, a hill descent control mode, a low 4×4 with hill descent control (HDC) mode, a low 4×4 without HDC mode, a sport adaptive mode, or a baja mode.

16. A vehicle comprising:
an engine;
a traction battery for selectively powering components of the vehicle when the engine is auto-stopped; and
a controller programmed to, in response to detecting an engine auto-stop condition, one of a set of preselected drive modes, and a shifter position change to one of a first set of shifter positions with a brake application, output an engine command to engage engine auto-start.

17. The vehicle of claim 16, wherein the first set of shifter positions is a sport mode, a normal mode, a tow/haul/grade assist mode, a mud and sand mode, a baja mode, a rock/crawl mode, an economy mode, a hill descent control mode, a low 4×4 with hill descent control (HDC) mode, a low 4×4 without HDC mode, or a sport adaptive mode.

18. The vehicle of claim 16, wherein the controller is further programmed to output an engine command to remain auto-stopped in response to detecting a brake release during the shifter position change to one of the first set of shifter positions.

19. The vehicle of claim 16, wherein the controller is further programmed to output an engine command for the engine to auto-start in response to detection of expiration of a predetermined time threshold and detection of a brake release.

20. The vehicle of claim 19, wherein the predetermined time threshold is based on an accessible driver input history.
